(19) United States
(12) Patent Application Publication
(10) Pub. No.: US 2007/0014223 A1
(43) Pub. Date: Jan. 18, 2007

(54) Method, system, playback device and recorder for duplicating multi layer record carriers

(76) Inventor: Robert Albertus Brondijk, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/574,363

(22) PCT Filed: Sep. 30, 2004
(86) PCT No.: PCT/IB04/51926

§ 371 Date: Mar. 30, 2006

(30) Foreign Application Priority Data
Oct. 6, 2003 (EP) 03103690.8

(51) Int. Cl. G11B 7/24

(52) U.S. Cl. 369/275.1

(57) ABSTRACT

When a multi layer record carrier comprising video information is to be duplicated on another multi layer record carrier the data spread over two recording layers on the source record carrier must also be spread over the two layers of the target record carrier. Once an appropriate layer transition for the target record carrier has been established the size of the first layer is adjusted by limiting the logical address space to exactly fit the video information obtained from the first layer of the source record carrier. Once the logical address space has been adjusted the layer transition will happen automatically at the correct point in the video information during the recording.

This invention relates to a recording device for recording information provided to an input on a multi layer record carrier with a first layer, a second layer and a layer transition point, the recording device comprising writing means for writing information on the first layer of the record carrier and a processing means coupled to the input and to the writing means,

and to a method for duplicating a source multi layer record carrier on a target record carrier.

Such a method is known from the present DVD copy programs available for personal computers.

Here a DVD reader retrieves the video information from the source multi layer record carrier, processes the video information and provides the processed video information to a DVD recorder for recording on a record carrier.

Because the DVD-ROM record carriers are available in a dual layer format the duplication of this type of record carrier is problematic on current recordable DVD record carriers because the current recordable DVD record carriers are single layer and provide only about half the recording capacity of the dual layer DVD ROM record carrier.

In order to fit video data from a dual layer DVD-ROM record carrier on a single layer DVD recordable record carrier the video information must be compressed which results in a loss of picture quality.

To this end a dual layer recordable DVD record carrier has been developed. This allows the duplication of the dual layer DVD-ROM record carrier while preventing the loss of picture quality due to compression because the dual layer DVD recordable provides enough storage capacity to hold the video information without further compression.

When receiving the video information the recording device is however faced with a problem.

Now that the DVD recordable comprises two recording layers compression is no longer required but a layer transition point must be established within the specifications of the DVD standard as applicable to DVD record carriers comprising video information in order to properly record the video information on the two layers of the target record carrier.

The recorder receives the video information and can process the video information to establish an appropriate point for the layer transition where the requirements of the DVD video standard are satisfied, i.e. the transition happens non-seamless and happens at a cell boundary. The recorder can scan the video information for a position where these conditions occur, and can consider whether that position is a suitable position, given the remaining capacity on the first layer of the record carrier, the remaining capacity required by the video information and the remaining capacity on the second layer. The disadvantage of this approach is the intensive processing of the video data by the recorder, requiring substantial processing power beyond the normal processing power required by the recording process itself.

It is an objective of the method of the present invention to overcome this disadvantage and provide an method for the recorder to determine an appropriate position of the layer transition point while substantially reducing the required processing power.

In order to achieve this objective the method comprising the steps of

retrieving video information from a first layer on the source multi layer record carrier

retrieving video information from a second layer on the source multi layer record carrier

retrieving a layer transition point from the source multi layer record carrier

transferring the video information retrieved from the first layer and the second layer to a recording device

transferring the layer transition position to the recording device

adjusting a maximum useable size of the first layer of the target multi layer record carrier based on the transferred layer transition position

recording the video information transferred to the recording device on the target multi layer record carrier.

By transferring the layer transition position from the source multi layer record carrier a scan of the video information is avoided, thus substantially reducing the processing power required to determine the layer transition point. In this way the processing performed in the authoring phase of the source multi layer record carrier is used by the recorder as a starting point. To obtain a layer transition the recorder reduces the useable size of the first layer based on the determined layer transition point such that when recording the video information an automatic layer jump is forced when the recording of the video information runs out of available space on the first layer of the target multi layer record carrier.

An embodiment of the method for duplicating a source multi layer record carrier is characterized in that the method comprises the step of adjusting the useable size of the first layer to the logical address of the transferred layer transition position. By adjusting, i.e. reducing, the useable size of the first layer to the logical address of the transferred layer position a layer transition is forced on the target multi layer record carrier that is identical to the layer transition on the source multi layer record carrier.

Thus when recording the video information from the source multi layer record carrier the recorder will reach the end of the logical address space available on the first layer when the video information from the first layer of the source record carrier has been recorded on the first layer of the target record carrier. Because the useable space on the first layer of the target record carrier is now completely filled the recorder will perform a layer transition to the second layer. Thus the video information from the first layer of the source record carrier fits exactly on the adjusted usable section on the first layer and the transition is exactly located at the same position in the video information as on the source record carrier, thus ensuring that the carefully chosen position of the layer transition of the source record carrier is maintained on the target record carrier.

A further embodiment of the method for duplicating a source multi layer record carrier is characterized in that the step of adjusting the useable size of the first layer is performed during the recording of the video information transferred to the recording device. The layer transition must be performed only at the end of the recording on the first layer of the target record carrier. Thus the recorder can either adjust the size of the first layer before recording in the first layer commences, or can start recording with the size of the first layer unadjusted and adjust the usable size of the first layer up until recording reaches the position of the layer transition point.

The latest point in time when the adjustment of the usable size of the first layer can be performed correctly depends on the processing speed of the recorder, in particular on the processing speed of the processor of the recorder, the delay of the basic engine in response to commands from the processor and the updating speed of the internal tables translating the logical address space to the physical address space. Due to the layer transition both the translation tables for the first layer and the second layer must be updated.

A further embodiment of the method for duplicating a source multi layer record carrier is characterized in that the step of adjusting the useable size of the first layer is performed after the recording of the video information transferred to the recording device and that the layer transition position is determined from a command.

Instead of embedding

The invention will now be described based on figures.

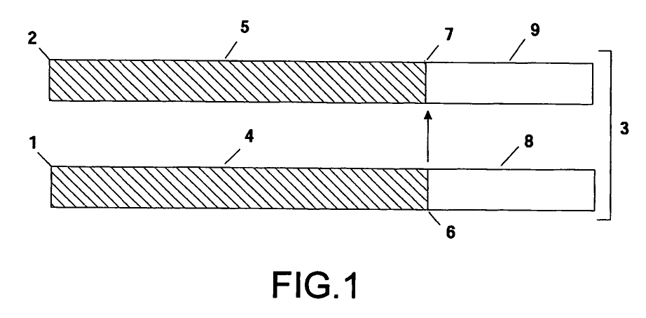

FIG. 1 shows video information recorded on a dual layer OTP record carrier.

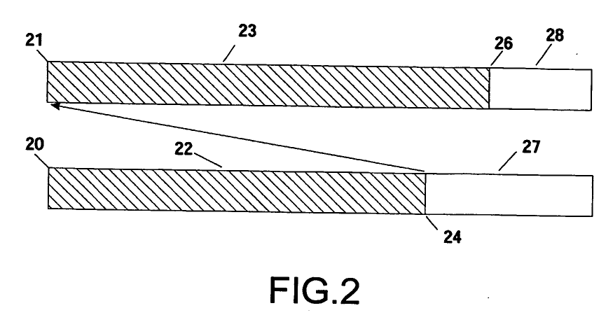

FIG. 2 shows video information recorded on a dual layer PTP record carrier.

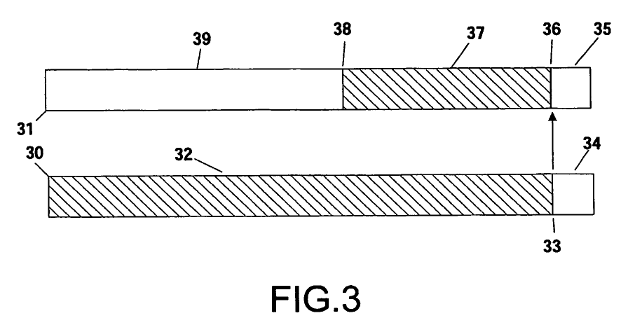

FIG. 3 shows video information duplicated on a dual layer OTP record carrier.

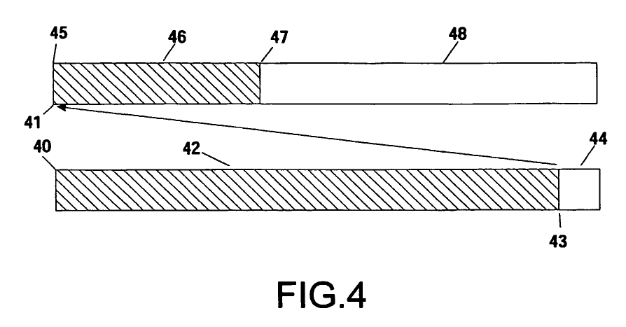

FIG. 4 shows video information duplicated on a dual layer PTP record carrier.

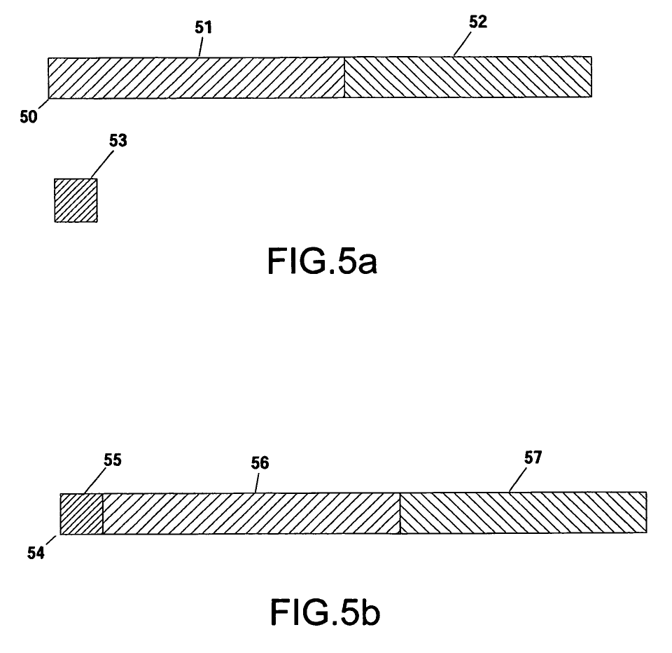

FIG. 5a shows a file structure for transferring the video information from a playback device to a recorder.

FIG. 5b shows a further file structure for transferring the video information from a playback device to a recorder.

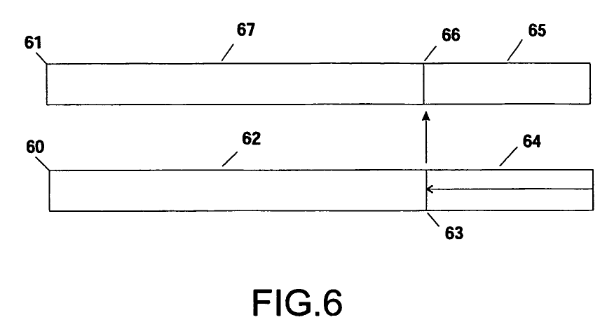

FIG. 6 shows a dual layer OTP record carrier prepared for duplicating another dual layer OTP record carrier.

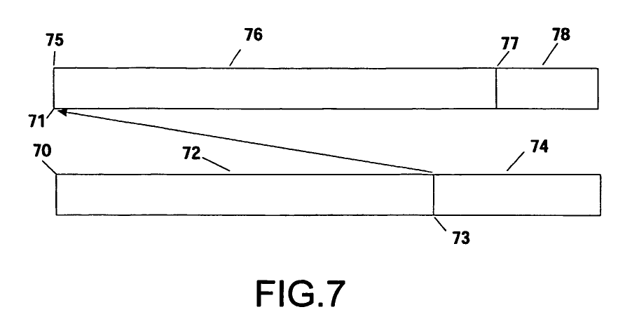

FIG. 7 shows a dual layer PTP record carrier prepared for duplicating another dual layer PTP record carrier.

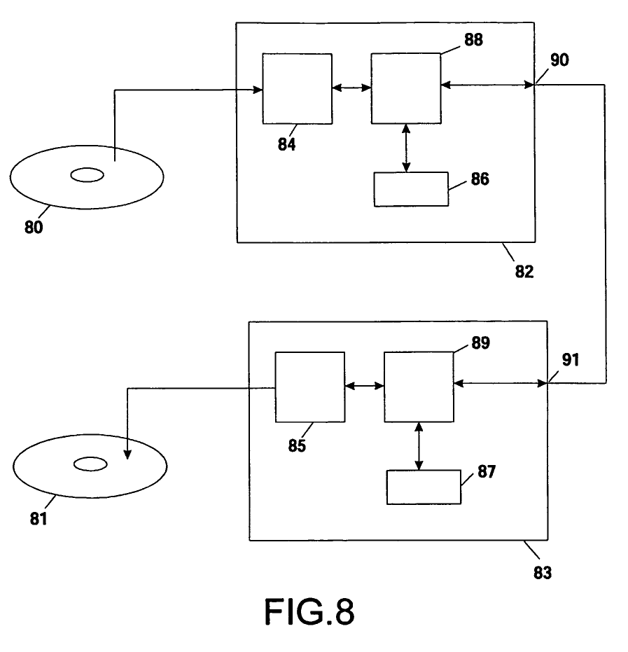

FIG. 8 shows a system for duplicating dual layer record carriers, comprising a playback device and a recorder.

FIG. 1 shows video information recorded on a dual layer OTP record carrier.

A record carrier 3 comprises a first layer 1 and a second layer 2 on which information is recorded. The information is video information, for instance an MPEG2 video stream. Because the video information doesn't fit on a single layer the first layer 1 comprises a first section 4 comprising video information and the second layer 2 also comprises a section with video information, the second section 5. Even if the video information would fit in it's entirety on the first layer 1 the publisher of the record carrier can still decide to split the video information in a first section on the first layer and a second section on a second layer for other reasons. Because the record carrier shown is of the OTP type the size of the first section 4 determines the maximum size of the second section 5. This is due to the fact that the first layer 1 is read from the start of the first layer outward up to the layer transition point 6 where the reading changes to the second layer 2 and continues inward through section 5. The second section 5 on the second layer 2 can thus never be larger than the first section 4 on the first layer 1.

The physical addressing of the layers spans the maximum size of the first layer and the maximum size of the second layer. In contrast to this the logical addressing on the OTP type record carrier runs from the start of the first section 4 on the first layer 1 outward to the layer transition point 6. The logical addressing continues at the start 7 of the second section and ends at the end of the second section 5.

Consequently a third section 8 on the first layer 1 and a fourth section 9 on the second layer are comprised in the physical addressing of the record carrier but not in the logical addressing. During mastering the layer transition point 6 is determined by processing the video data and searching for an appropriate scene, for instance with a low bit rate, occurring at a cell boundary where a non-seamless layer transition can be implemented. An additional objective is often to balance the amount of video information on both layers 1,2 and thus obtaining a first section 4 and a second section 5 that are approximately equal in size. This reduces the amount of padding required to fill the remaining area of the second section 5 not filled by the video information.

FIG. 2 shows video information recorded on a dual layer PTP record carrier.

A PTP type record carrier comprises a first layer 20 and a second layer 21 on which information is recorded. The information is video information, for instance an MPEG2 video stream. Because the video information doesn't fit on a single layer the first layer 20 comprises a first section 22 comprising video information and the second layer 21 also comprises a section with video information, the second section 23. Of course the publisher of the record carrier can decide to split the information over the two layers 20,21 for other reasons as well. Because the record carrier shown is of the PTP type the size of the first section 22 has no influence on the size of the second section 23. This is due to the fact that the first layer 20 is read from the start of the first layer outward up to the layer transition point 24 where the reading changes to the start 25 of the second layer 21 and again continues outward through the second section 23 up to the end 26 of the second section 23.

The physical addressing of the layers spans the maximum size of the first layer 20 and the maximum size of the second layer 21. In contrast to this the logical addressing on the PTP type record carrier runs from the start of the first section 22 on the first layer 20 outward to the layer transition point 24. The logical addressing continues at the start 25 of the second section 23 and ends at the end 26 of the second section 23.

Consequently a third section 27 on the first layer 20 and a fourth section 28 on the second layer 21 are comprised in the physical addressing of the record carrier but not in the logical addressing. During mastering the layer transition point 24 is determined by processing the video data and searching for an appropriate scene, for instance with a low bit rate, occurring at a cell boundary where a non-seamless layer transition can be implemented. On a PTP record carrier there is no specific additional objective to balance the amount of video information on both layers 20, 21. Consequently the first section 22 and a second section 23 can have different sizes and the second section 23 can be smaller, equal or larger than the first section 22.

FIG. 3 shows video information duplicated on a dual layer OTP record carrier.

When a dual layer OTP record carrier as shown in FIG. 1 is duplicated in the regular fashion the video information is retrieved from logical address space of the source record carrier and provided to the recorder for recording on the target record carrier. A single stream or data file with video information is provided to the recorder and consequently the recorder must, just like during authoring, find a suitable point in the video information for the layer transition point. FIG. 3 shows a layer transition point determined by the recorder close to the physical end of the first layer 30. The first layer 30 comprises a first section 32 comprising the first part of the video information. The layer transition point 33 marks the end of the first section 32 and of the logical address space of the first layer 30. The video information and the logical address space continues on the second layer, from the start 36 of the second section 37 to the end 38 of the second section 37. The recorder can of course also apply further rules for the layer transition point for instance to ensure a balancing of the amount on video information comprised in each section 32, 37 to reduce padding. In a situation as shown in FIG. 3 padding would be required of the third section 39. The fourth section 34 and fifth section 35 are not comprised in the logical addressing. The drawback of this method of copying is that the video information must be processed and that potentially a relatively large section of the second layer must be padded to fill the remaining logical space of the second layer 31.

FIG. 4 shows video information duplicated on a dual layer PTP record carrier.

Just like the description of FIG. 3 FIG. 4 shows what happens when no special measures are taken when copying a source multiplayer record carrier to a target multiplayer record carrier.

When a dual layer PTP record carrier as shown in FIG. 2 is duplicated the video information is retrieved from logical address space of the source record carrier and provided to the recorder for recording on the target record carrier. A single stream or data file with video information is provided to the recorder and consequently the recorder must, just like during authoring, find a suitable point in the video information for the layer transition point. FIG. 4 shows a layer transition point 43 determined by the recorder close to the physical end of the first layer 40. The first layer 40 comprises a first section 42 comprising the first part of the video information. The layer transition point 43 marks the end of the first section 42 and of the logical address space of the first layer 30. The video information and the logical address space continues on the second layer, from the start 45 of the second section 46 to the end 47 of the second section 46. The recorder can of course also apply further rules for the layer transition point for instance to ensure a balancing of the amount on video information comprised in each section 42, 46. The third section 44 and fourth section 48 are not comprised in the logical addressing. The drawback of this method of copying is that the video information must be processed.

FIG. 5a shows a file structure for transferring the video information from a playback device to a recorder.

In order to avoid the mandatory processing of the video information FIG. 5a shows a file structure 50, 53 that comprises a first file 50 and a second file 53. The first file comprises the video information of the source multiplayer record carrier. Because the playback device only provides a single stream or file with a continues logical address space comprising both the first section 51 of the video information read from the first section on the first layer and the second section 52 of the video information read from the second section on the second layer of the source multiplayer record carrier, a second file 53 is provided by the recorder in addition to the first file 50. The second file 53 comprises the logical address of the layer transition point. This way the recorder does no longer need to process the video information but can use the provided logical address of the original layer transition point of the source record carrier to determine the appropriate layer transition point for the target record carrier.

A constant offset in the physical address space of the target record carrier compared to the source record carrier can be easily taken into account by the recorder. An advantage of a separate second file 53 is that this second file 53 can be transferred to the recorder independent of the first file 50 comprising the video information.

Because the recorder must know the position of the layer transition point before the recording of the video information has advanced to the layer transition point the second file can transferred at any time before the recorder reaches the layer transition point. The playback can thus transfer the second file 53 either before the first file 50, or concurrently with the first section 51 of the first file 50. Before the recording of the second section 52 of the first file commences the recorder must have received the second file 53. In the DVD file structure a suitable file to comprise the logical address of the layer transition point is the IFO file which also contains other information pertinent to the video information in the VOB file or VOB files.

FIG. 5b shows a further file structure for transferring the video information from a playback device to a recorder.

Another possibility is to include the logical address of the layer transition information in a section 55 of the first section 56 of the file 54 comprising the first section of the video information. Shown is the situation where the section 55 comprising the logical address of the layer transition point is located at the beginning of the first section 56, but other positions in the first section 56 are also suitable. The second section 57 of the file 54 is to be recorded on the second layer of the target record carrier. Hence, before the recording of the video information comprised in the second section 57 commences the layer transition point must be established.

Now that the effects of the regular duplication process have been explained in FIGS. 1, 2, 3 and 4, FIG. 6 will show how transferring the position of the layer transition point to the recorder can be used to obtain an appropriate layer transition on the target record carrier.

FIG. 6 shows a dual layer OTP record carrier prepared for duplicating another dual layer OTP record carrier.

The dual layer record carrier of FIG. 6 comprises a first layer 60 and a second layer 61. The first layer comprises a first section 62 to record the first section 51 of video information of FIG. 5a. The recorder has arranged for a layer transition point 63 located such that the first section 51 of video information of the file 50 of FIG. 5a fits exactly in the first section 62 of the first layer 60 the target record carrier.

The remaining second section 52 of the video information of the file 50 of FIG. 5a can be subsequently recorded in the second section 67 of the second layer 61 of the target record carrier. To achieve this the recorder reduces the maximum logical addressing space of the first layer 60 to coincide with the logical address of the layer transition point as retrieved from the second file 53 of FIG. 5a or determined from the video information itself by the recorder.

It should be noted that instead of reading the logical address of the transition point on the source record carrier from the second file 53 of FIG. 5a, an appropriate layer transition point can also be derived from the video information itself by processing the video information and searching for a position in the video information where certain conditions are met, in particular where a non-seamless transition can be used, where a cell boundary is located and positions where the video information contains a scene meeting certain criteria regarding bit rate and content of the scene. A low bit rate and a dark scene or a scene without action or fast moving contents are examples of positions of the video information suitable for a layer transition point.

Thus, when the recorder starts recording the video information from the first file 50 of FIG. 5a the layer transition is automatically forced because the recorder reaches the adjusted maximum logical addressing space of the first layer 60, corresponding to the end of the first section 62 exactly when the recording of the video information has progressed to that point in the video information where the layer transition point was located on the source record carrier. The recorder already includes all necessary means to allow the recorder to perform an automatic layer transition when the maximum logical address of the first layer is reached. By adjusting, i.e. spoofing, the maximum logical address on the first layer the means in the recorder to perform an automatic layer transition will be triggered by the reaching of the maximum logical address during the recording and will perform a layer transition automatically. When the maximum logical address on the first layer was left at the maximum logical address supported by the medium the automatic layer transition would be performed at a potentially inappropriate position in the video information. It is the adjustment of the maximum logical address of the first layer to correspond with the logical address of the layer transition on the source record carrier that ensures that the layer transition on the target record carrier is located at the same appropriate position on in the video information on the target record carrier as was chosen carefully during the authoring of the record carrier. When reaching the maximum addressing space of the first layer 60 the recorder automatically performs a layer transition and continues recording the remaining video information from the start 66 of the second section 52 of the first file 50 of FIG. 5a in the second section 67 on the second layer 61. No recording in the third section 64 and the fourth section 65 will be performed since the third section 64 is beyond the adjusted maximum address space of the first layer and is consequently inaccessible for the recorder of the adjustment of the maximum address space of the first layer 60.

This is however not a drawback because the third section 64 is not needed for the recording of the video information anymore.

Because on an OTP type record carrier the recorder records inward after the layer transition the fourth section 65 becomes inaccessible to the recorder after the adjustment of the maximum addressing space just like the third section 64.

FIG. 7 shows a dual layer PTP record carrier prepared for duplicating another dual layer PTP record carrier.

The dual layer record carrier of FIG. 7 comprises a first layer 70 and a second layer 71. The first layer 70 comprises a first section 72 to record the first section 51 of video information of FIG. 5a The recorder has arranged for a layer transition point 73 located such that the first section 51 of video information of the file 50 of FIG. 5a fits exactly in the first section 72 of the first layer 70 the target record carrier.

The remaining second section 52 of the video information of the file 50 of FIG. 5a can be subsequently recorded in the second section 76 of the second layer 71 of the target record carrier. To achieve this the recorder reduces the maximum addressing space of the first layer 70 to coincide with the logical address of the layer transition point retrieved from the second file 53 of FIG. 5a or determined from the video information itself by the recorder.

It should be noted that an appropriate layer transition point can also be derived from the video information itself by processing the video information and searching for a position in the video information where certain conditions are met, in particular where a non-seamless transition can be used, where a cell boundary is located and positions where the video information contains a scene meeting certain criteria regarding bit rate and content of the scene. A low bit rate and a dark scene or a scene without action or fast moving contents are examples of positions of the video information suitable for a layer transition point.

Thus, when the recorder starts recording the video information from the first file 50 of FIG. 5a the layer transition is automatically forced because the recorder reaches the adjusted maximum addressing space of the first layer 70, corresponding to the end 73 of the first section 72 exactly when the recording of the video information has progressed to that point in the video information where the layer transition point was located on the source record carrier.

When reaching the maximum addressing space of the first layer 70 the recorder automatically performs a layer transition and continues recording the remaining video information from the second section 52 of the first file 50 of FIG. 5a in the second section 76 on the second layer 71. No recording in the third section 74 and the fourth section 78 will be performed since the third section 74 is beyond the adjusted maximum address space of the first layer and is consequently inaccessible for the recorder of the adjustment of the maximum address space of the first layer 70.

Because on an PTP type record carrier the recorder commences outward from the start 75 of the second section 76 after the layer transition the fourth section 78 remains accessible to the recorder after the adjustment of the maximum addressing space, unlike the third section 74 of the first layer 70. The end 77 of the second section 76 is determined by the end of the video information.

Although the explanation of FIGS. 6 and 7 uses the file structure of FIG. 5a, the file structure of FIG. 5b can be used equally well.

FIG. 8 shows a system for duplicating dual layer record carriers, comprising a playback device and a recorder.

A source dual layer record carrier 80 is to be duplicated on the target dual layer record carrier 81. A playback device 82 can access the information on the source record carrier through a basic engine 84 which performs the readout and decoding of the information read from the record carrier 80. The processor 88 is coupled to the basic engine 84 and can both issue instructions to the basic engine 84 and receive the information retrieved by the basic engine 84. Using the basic engine 84 the processor can retrieve both the video information and the logical address of the layer transition point from the source record carrier 80 by first retrieving the video information from the first layer of the source record carrier 80, noting the logical address of the layer transition point, and subsequently retrieving the remaining video information from the second layer of the source record carrier 80. The processor 88 is further coupled to a user interface 86 and to an output 90. Through the user interface 86 the user can instruct the playback device to start a duplication process, initiated by the playback device or can adjust the format of the files or data stream provided by the playback device 82 to the recorder 83. For instance a selection between the two file formats illustrated in FIG. 5a and FIG. 5 b respectively can be achieved to ensure compatibility if different recorders require different file formats. The user can also instruct the playback device to suppress the output of the logical address of the layer transition point to the recorder or to a file.

The file, files, or data stream comprising the video information and the logical address of the layer transition point are provided by the processor 88 via the interface 90 to the input 91 of the recorder 83. When the recorder 83 receives the file, files, or data stream comprising both the video information and the logical address of the layer transition point the input 91 provides the file, files or data stream to the processor 89.

The processor 89 is coupled to a user interface 87. Through the user interface 87 the user can instruct the recorder to start a duplication process, or instruct the recorder to initiate the transfer of the files from the playback device 82 to the recorder 83. In addition the user interface 87 can be used to adjust the format of the files or data stream accepted by the recorder 83 from the playback device 82. For instance a selection between the two file formats illustrated in FIG. 5a and FIG. 5 b respectively can be achieved to ensure compatibility if different playback devices provide different file formats. The user interface 87 can also be used to instruct the recorder 83 to ignore the logical address of the layer transition point as provided by the playback device and instead process the video information to locate an appropriate position for the layer transition point

For the duplicating process the playback device 82 performs the following steps:

retrieving video information from a first layer on the source multi layer record carrier using the basic engine 84 under control of the processor 88 where the optical pickup is focused on the first layer.

retrieving video information from a second layer on the source multi layer record carrier using the basic engine 84 under control of the processor 88 where the optical pickup is in this case focused on the second layer.

transferring all video information retrieved from the first layer and the second layer to a recording device.

The transfer can be initiated by the user through the user interface 86 of the playback device 82 or through the user interface 87 of the recorder 83. Alternatively the transfer can be initiated through the interfaces 90, 91 of the playback device 82 and/or recorder 83 in case the playback device 82 and/or the recorder 83 are computer controlled through their interfaces, for instance in the case of IDE-interface controlled playback devices and recorders used in Personal Computers.

determining a logical address of the layer transition position.

The recorder then must determine the logical address of the layer transition position.

This can be achieved by obtaining the logical address of the layer transition point on the source record carrier from the playback device, for instance by retrieving this logical address from a file provided by the playback device, or by processing the video information and determining the logical address of an appropriate position for a layer transition.

adjusting a maximum useable size of the first layer of the target multi layer record carrier based on the transferred layer transition position

By adjusting the maximum logical address space on the first layer the translation from physical address space to logical address space is changed because at the maximum logical address of the first layer a layer transition is performed and the logical addressing continues on the second layer as outlined in FIGS. 6 and 7.

recording the video information transferred to the recording device on the target multi layer record carrier

The recorder 83 records the received video information on the target multi layer record carrier 81 by processing the video information using the processor 89. The processor 89 subsequently provides the video information in an appropriate form, as defined by the recording standard, together with other required information such as addressing information to the basic engine 85 where the information is converted into a signal suitable for recording on the target multi layer record carrier 81.

To implement the layer transition point the processor 89 of the recorder 83 can, before or during recording of the first layer of the target multi layer record carrier 81, adjust the maximum address space of the first layer of the target record carrier 81. When adjusting the maximum address space of the first layer the layer transition is performed automatically when the recorder reaches the adjusted maximum logical address at the end of the addressing space.

When the logical address of the layer transition point is not determined by processing the video information the playback device needs to perform the following additional two steps:

retrieving a layer transition point from the source multi layer record carrier, using the basic engine 84 under control of the processor 88. The logical address of the layer transition point can be determined in several ways. The playback can retrieve the logical address of the layer transition position from an entry in the lead-in of the record carrier or can determine the position of the layer jump by noting the logical address of the layer transition point while retrieving the video information from the source record carrier. For duplication all video information must be retrieved from the record carrier and the playback will thus, in the case of a dual layer source record carrier, automatically encounter the layer transition.

transferring the layer transition point to the recording device

The transfer of the logical address of the layer transition point can be initiated by the user through the user interface 86 of the playback device 82 or through the user interface 87 of the recorder 83. Alternatively the transfer can be initiated through the interfaces 90, 91 of the playback device 82 and/or recorder 83 in case the playback device 82 and/or the recorder 83 are computer controlled through their interfaces, for instance in the case of IDE-interface controlled playback devices and recorders used in Personal Computers. It is obvious that the transfer of the logical address of the layer transition point can be transferred separate or together with the transfer of the video information.

When the logical address of the layer transition point is determined by processing the video information the playback device needs to perform the following additional step instead of the two additional steps outlined above:

processing the video information to determine a logical address for a layer transition point complying with requirements for a layer transition.

1. Recording device for recording information provided to an input on a multi layer record carrier with a first layer, a second layer and a layer transition point, the recording device comprising writing means for writing information on the first layer and the second layer of the multi layer record carrier and a processing means coupled to the input and to the writing means, characterized in that the processing means is operative to determine a layer transition point from an input stream and to adjust a maximum logical address space of the first layer based on the determined layer transition point.

2. Recording device as claimed in claim 1,
characterized in that the adjusted maximum logical address of the first layer coincides with the retrieved layer transition point.

3. Method for duplicating a source multi layer record carrier on a target multi layer record carrier the comprising the steps of
retrieving video information from a first layer on the source multi layer record carrier
retrieving video information from a second layer on the source multi layer record carrier
transferring the video information retrieved from the first layer and the second layer to a recording device
determining a logical address for a layer transition point
adjusting a maximum logical address of the first layer of the target multi layer record carrier based on the determined logical address for the layer transition point
recording the video information transferred to the recording device on the target multi layer record carrier.

4. Method for duplicating a source multi layer record carrier as claimed in claim 3 characterized in that the step of determining a logical address for the layer transition point comprises the step of:
processing the transferred video information to determine a logical address for a layer transition point complying with requirements for a layer transition

5. Method for duplicating a source multi layer record carrier as claimed in claim 3,
characterized in that step of determining a logical address for the layer transition point comprises the steps of
retrieving a layer transition point from the source multi layer record carrier
transferring the layer transition point to a recorder
determining a logical address for a layer transition point from the transferred layer transition point

6. Method for duplicating a source multi layer record carrier as claimed in claim 3,
characterized in that the step of adjusting a maximum logical address of the first layer of the target multi layer record carrier is performed during the recording of the video information transferred to the recording device.

7. Method for duplicating a source multi layer record carrier as claimed in claim 3,
characterized in that the step of adjusting a maximum logical address of the first layer of the target multi layer record carrier is performed after the recording on the first layer of the video information transferred to the recording device and that the layer transition position is determined from a command.
